(19) United States
(12) Patent Application Publication
(10) Pub. No.: US 2022/0202034 A1
(43) Pub. Date: Jun. 30, 2022

(54) IMPROVED EDIBLE FAT COMPOSITION

(71) Applicant: AAK AB, Malmo (SE)

(72) Inventors: Karsten NIELSEN, Malmo (SE); Bjarne JUUL, Malmo (SE)

(21) Appl. No.: 17/611,685

(22) PCT Filed: May 21, 2020
(86) PCT No.: PCT/SE2020/050525

§ 371 Date: Nov. 16, 2021

(30) Foreign Application Priority Data
May 21, 2019 (SE) 1930165-4

(51) Int. Cl. A23G 1/36; A23D 9/02

(52) U.S. Cl. CPC A23G 1/36; A23D 9/02

(57) ABSTRACT

The present invention relates to a method for producing a bloom-retarding component for chocolate and chocolate-like products, said method comprising the steps of: —providing a triglyceride composition (TGC) comprising 40 to 95 wt % monounsaturated symmetrical triglycerides (TGs) selected from POP, StOSt, and POSt; —heat treating the TGC in a closed vessel for at least 1 hour and at a temperature of at least 220° C. to form a heat-treated triglyceride composition (HT TGC); and —deodorizing the HT TGC from the heating step to form a deodorized heat-treated triglyceride composition (DZ/HT TGC), wherein P is palmitic acid, St is stearic acid, and O is oleic acid. Further, the invention relates to products obtained by such a method, and their uses in chocolate products.

### TECHNICAL FIELD

The present invention relates to the field of chocolate or chocolate-like products. More specifically the present invention relates to bloom-retarding components based on cocoa butter or similar compositions. Even more specifically, the present invention relates to bloom-retarding components having reduced amounts of chloro-propanol compounds such as 2- and 3-MCPD.

### BACKGROUND

Across the world, chocolate is regarded as being one of the finest types of confectionary, and various types and shapes of chocolate have been developed over the years. Innovation within the field of chocolate has been much focused on sensory aspects, such as taste, and mouthfeel. However, the visual appearance of the chocolate is also an important consideration for a consumer's overall perception of the quality of a chocolate product. Accordingly, the visual appearance of a chocolate product plays an increasingly key role for chocolate manufacturers, particularly as a less attractive appearance will be equated by the consumer to inferior quality.

One of the key issues relating to the visual appearance of a chocolate product is the formation of bloom effects, which are easily recognizable on the surface of the chocolate. Where blooming has occurred, the surface of the chocolate will appear unglossy and dull, and often have clearly visible bloom crystals on the surface. The appearance of bloom can occur at any time, but typically takes place after weeks or months of storage.

Chocolate itself generally comprises cocoa butter, cocoa solids and sugar. Milk fat and/or milk proteins, emulsifies, and other ingredients may also be present in chocolate compositions.

During manufacturing, the ingredients are mixed and subjected to a tempering process (in a tempering apparatus) in which the chocolate is subjected to a carefully pre-programmed temperature profile. The tempering process is of great importance as it produces a sufficient amount of a desired type of seed crystal of the solid fats present in the chocolate, which in turn is responsible for producing a more stable chocolate product less prone to changes in the crystal composition of the solid fats. The desired seed crystals are of the crystal Form V. It is believed that the bloom effect seen in chocolate products results from polymorph transformation of the fat crystals present in the chocolate.

Bloom in chocolate is a well-studied phenomenon and among chocolate manufactures it is believed that the bloom effect may in some cases be related to solid fat crystals transforming from the crystal Form V into Form VI crystals. Such recrystallization into Form VI crystals may then accordingly result in bloom on the surface of the chocolate confectionary.

It should be noted though, that bloom may also occur in a chocolate product where the chocolate has been poorly and/or insufficiently tempered.

Subsequent to the tempering process, the chocolate is cooled following a predetermined cooling program.

Various solutions for avoiding the formation of bloom effect in chocolates have been proposed. Such solutions have included, for example, optimizing tempering conditions, adding high-melting milk fat fractions, or sorbitan tristearate to the chocolate. Further, the addition of bloom-retarding agents having specific tri-glyceride compositions have also been proposed. These bloom-retarding agents are typically based on vegetable fats obtained by chemical interesterification of triglyceride oils using specifically selected catalysts. Another example of such a solution is described in WO2014/071955.

It is also well known in this field that 3-monochloropropane-1,2-diol (3-MCPD), 2-monochloropropane-1,3-diol (2-MCPD), glycidol, and fatty acid esters thereof are formed during physical refining of vegetable oils and fats as a result of thermal treatment during processing. For foodstuffs, such as edible oils and fats and infant foods, for example formula, these compounds present a significant problem as they are considered to be carcinogenic and potentially genotoxic, as well as to effect kidneys. As a result, it is desired to avoid the presence of these compounds in refined triglyceride fats and oils. However, the problems with these compounds are compounded by the fact that knowledge of the exact mechanisms of their formation is limited.

As noted above, WO2014/071955 proposes a solution to the problem of bloom formation. However, it has been found that the formation of glycidol, 2-MCPD, 3-MCPD, and esters thereof is an issue, not least due to the presence of a high temperature thermal treatment.

Accordingly, there is a need in the art of manufacturing chocolate or chocolate-like products, for a method capable of producing bloom-retarding components, which method is able to avoid and/or significantly reduce the formation of 2-, 3-MCPD, glycidol, or esters thereof.

### SUMMARY

In one aspect, the present invention relates to a method for producing a bloom-retarding component for chocolate and chocolate-like products, said method comprising the steps of:
Providing a triglyceride composition (TGC) which comprises of 40 to 95 wt % mono-unsaturated symmetrical triglycerides (TGs) selected from POP, StOSt, and POSt;
Heat treating the TGC in a sealed vessel for at least 1 hour and at a temperature of at least 220° C. to form a heat-treated triglyceride composition (HT TGC); and
Deodorizing the HT TGC from the heating step to form a deodorized heat-treated triglyceride composition (DZ/HT TGC),
   wherein P is palmityl (i.e. palmitic acid), St is stearyl (i.e. stearic acid) and O is oleyl (i.e. oleic acid).

In a further aspect, the present invention relates to a deodorized heat-treated triglyceride composition (DZ/HT TGC) produced in accordance with the methods described herein.

In yet a further aspect, the present invention relates to a method of manufacturing a chocolate or chocolate-like product comprising the step of adding a deodorized heat-treated triglyceride composition (DZ/HT TGC) as described herein as the only vegetable fat.

In still a further aspect, the present invention relates to a chocolate or chocolate-like product comprising at least 2% of a deodorized heat-treated triglyceride composition (DZ/HT TGC) as described herein.

In still yet a further aspect, the present invention relates to a chocolate, comprising as the only vegetable fat component, cocoa butter, and wherein at least 4% by weight of the cocoa butter has been processed in accordance with the methods described herein.

In still yet another aspect, the present invention relates to use of a deodorized heat-treated triglyceride composition (DZ/HT TGC) as described herein as a bloom-retarding component for chocolate and chocolate-like products.

The aspects of the inventions are described in further detail below, and with reference to the accompanying Figures, in which:

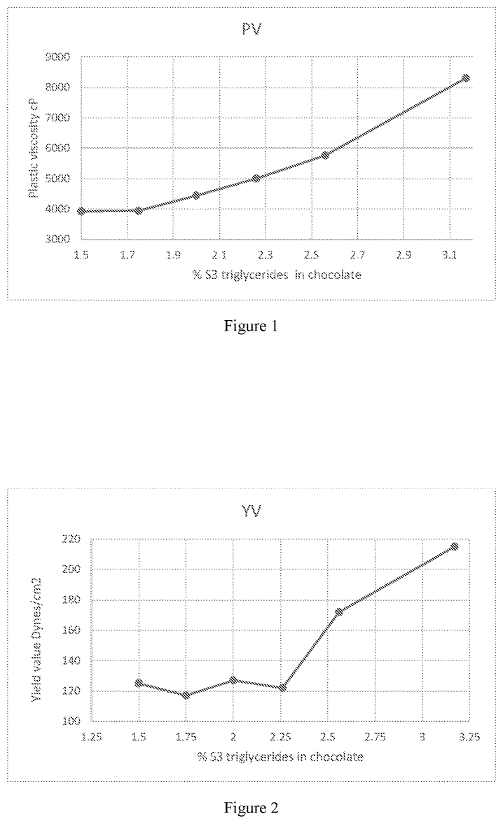

FIG. 1 of the accompanying drawings is a graph which illustrates the effect of % S3 triglyceride content on the plastic viscosity of chocolate; and

FIG. 2 of the accompanying drawings is a graph which illustrates the effect of % S3 triglyceride content on the yield value of chocolate.

### DETAILED DESCRIPTION

### Definitions

As used herein, the terms “%” or “percentage” all relate to weight percentage i.e. wt % or wt-% if nothing else is indicated.

As used herein, the singular forms “a”, “an” and “the” are intended to include reference to the plural forms unless otherwise stated.

As used herein, the term “at least one” is intended to mean one or more, i.e. 1, 2, 3, 4, 5, 6, 7, 8, 9, 10, etc.

As used herein, the term “cocoa butter equivalent” (CBE) is intended to mean an edible fat having very similar chemical and physical properties and being compatible with cocoa butter without any significant effect on the behavior of the chocolate. In both cocoa butter and cocoa butter equivalent the fatty acids are typically palmitic, stearic and oleic acids (and also linoleic and arachidic) and the triglycerides are typically 2-oleo di-saturated (SatOSat). In spite of their similarity to cocoa butter, cocoa butter equivalents can be detected in chocolate by their triglyceride ratios which are appreciably different from those in cocoa butter. CBEs may be made from oils including palm oil, illipe butter, shea butter, kokum butter and sal fat. For example, a suitable CBE could be made from a mix of palm mid-fraction and a fractionated part of shea stearin or other oil fraction rich in SatOSat triglycerides, where Sat is a saturated fatty acid having a carbon chain length of greater than C16 (i.e. C16:0) or C18 (i.e, C18:0).

As used herein, the term “cocoa butter improver” (CBI) is intended to mean a harder version (i.e. one with a higher solid fat content) of cocoa butter equivalent due to a higher content of high melting SatOSat triglycerides such as StOSt triglycerides and/or StOA triglycerides. CBIs are usually used in chocolate formulations having a high content of milk fat or those meant for tropical climates. CBIs improve the heat stability of soft cocoa butters, adds more solid fat and thereby increases hardness in chocolate products.

As used herein, the term “cocoa butter replacer” (CBR) is intended to mean an edible fat having a triglyceride composition similar to, but not identical to, cocoa butter. The distribution of fatty acid is similar to cocoa butter, but the structure of the triglycerides is completely different. Typically, the fatty acids are non-lauric fats, and may include elaidic, stearic, palmitic and linoleic. CBRs may be made from oils including hydrogenated oil, soya oil, canola oil, cotton seed oil, ground nut oil and palm olein. Cocoa butter replacers are only mixable with cocoa butter in small ratios, such as up to 20% by weight.

As noted above, an aspect of the present invention provides a method for producing a bloom-retarding component for chocolate and chocolate-like products, said method comprising the steps of:
Providing a triglyceride composition (TGC) which comprises of 40 to 95 wt % mono-unsaturated symmetrical triglycerides (TGs) selected from POP, StOSt, and POSt;
Heat treating the TGC in a sealed vessel for at least 1 hour and at a temperature of at least 220° C. to form a heat-treated triglyceride composition (HT TGC); and
Deodorizing the HT TGC from the heating step to form a deodorized heat-treated triglyceride composition (DZ/HT TGC),
   wherein P is palmityl (i.e. palmitic acid), St is stearyl (i.e. stearic acid) and O is oleyl (i.e. oleic acid).

In the context of the present disclosure, the term “chocolate product” is intended to refer to a product which contains up to a maximum of 5% by weight of vegetable fats other than cocoa butter, the percentage being by weight of the total amount of ingredients in the chocolate product.

Likewise, a “chocolate-like product” is intended to refer to a product which contains more than 5% by weight of vegetable fats other than cocoa butter, the percentage being by weight of the total amount of ingredients in the chocolate-like product.

A “sealed vessel” is herein intended to refer to a vessel, wherein in use, there is no loss of material from the vessel, and in use is operated in the absence of oxygen.

By “bloom-retarding component”, it is intended to refer to a fat composition which is suitable for, in use, preventing, reducing, retarding or delaying fat bloom formation. For example, chocolate or chocolate-like products formed using the bloom-retarding component described herein may be stable and not display the presence of fat blooming for periods of at least 10 days, 50 days, 100 days, 10 weeks, for example at least 18 weeks, and even as much as 50 weeks, or 80 weeks.

It has surprisingly been found that a heat treatment step in combination with a deodorization step may be used to obtain not only a bloom-retarding component formed from triglyceride compositions that are not commonly subjected to such relatively harsh process conditions (i.e. vegetable triglyceride compositions rich in symmetric triglycerides which are usually chemically altered under heating), but also one which additionally comprises reduced levels of 2-, and 3-MCPD as well as glycidol and esters thereof, compared to previously known processes. For example, the amount of glycidol, 2-MCPD, 3-MCPD, or esters thereof may be reduced by at least 50% compared to the method described in WO2014/071955, on a like-for-like comparison.

In particularly preferred embodiments, the deodorized and heat treated triglyceride may comprise less than 0.5 ppm 2-MCPD (preferably less than 0.1), less than 0.5 ppm 3-MCPD (preferably less than 0.1), and/or less than 1.0 ppm of glycidyl esters (preferably less than 0.8, such less than 0.5). It will be appreciated that it is preferred for the composition to contain reduced amounts of 2-MCPD, 3-MCPD and glycidyl esters.

It is well known in the art that high temperatures during deodorization, as well as lengthy process times of such composition, generally result in the formation of unwanted glycidol, 2-MCPD, 3-MCPD, or esters thereof.

Triglyceride compositions rich in symmetric triglycerides are regarded as valuable due to their content of symmetric triglycerides which result in good crystallization properties and high Solid Fat Content (SFC). Accordingly, introducing asymmetry at the cost of symmetry is regarding in the art as extremely adverse. The present inventors have previous shown that the relative amount of asymmetric mono-unsaturated triglycerides (i.e. SSO) in triglyceride compositions rich in monounsaturated symmetric triglycerides can be surprisingly raised by a deodorization process (see WO2014/071955).

Particularly important symmetric triglycerides are POP, StOSt and POSt. Compositions comprising substantial amounts of these triglycerides are not normally deodorized at high temperatures for long time, because even minor changes in the triglyceride composition are often compromising to the physical and chemical properties, when the composition is to be used, for example, as an ingredient in connection with the production of confectionary products. If, for example, a CBE, is desired, the melting properties of the CBE are crucial for the successful production of the confectionary product.

Thus, compositions rich in POP, POSt and StOSt may be treated according to the process described herein and used as a bloom-retarding component in confectionary compositions, for example in CBE compositions, without affecting the manufacturing process and the sensory and textural properties of the confectionary product too much, still having a reduced level of glycidol, 2-MCPD, 3-MCPD, or esters thereof.

In one embodiment, the triglyceride composition (TGC) consists essentially of mono-unsaturated symmetrical triglycerides (TGs) selected from POP, StOSt, and POSt, and could potentially consist of mono-unsaturated symmetrical triglycerides (TGs) selected from POP, StOSt, and POSt.

According to the method described herein, the heat treatment step is undertaken in a sealed vessel, which step is followed by a deodorization step. The deodorization step may be undertaken by means of a vessel having an outlet for distillate, which vessels are well known in the art. As noted above, such steps in combination are surprisingly able to produce a bloom-retarding component for chocolate and chocolate-like products having bloom-inhibiting triglycerides (SSO), and an optimal SSO/SSS ratio, whilst at the same time comprising a significantly lower content of glycidol, 2-MCPD, 3-MCPD, or esters thereof. In particular, the bloom-retarding component preferably has a SSO/SSS ratio of from 0.4 to 1.7, more preferably from 0.5 to 1.6, and most preferably from 0.8 to 1.5.

The deodorization step is preferably performed under standard conditions such as described herein.

The heat treatment step may be undertaken for 1 to 8 hours, for example from 2 to 7 hours, or even 4 to 6 hours.

The heat treatment step may be undertaken at a temperature of from 220 to 260° C., for example from 230 to 250° C., or even 245 to 260° C.

In a particular embodiment, the heat treatment step may be undertaken for 1 to 8 hours and at a temperature of 220 to 260° C. In a further particular embodiment, the heat treatment step may be undertaken for 4 to 6 hours and at a temperature of 245 to 260° C.

The sealed vessel of the heat treatment step may be operated under vacuum, such as a vacuum of up to 2 mbar. It will be appreciated that such a vacuum may be, for example, from 0.1 to 1.5 mbar, including 0.3 to 1.0 mbar, and even 0.3 mbar.

The sealed vessel of the heat treatment step may be operated under an inert atmosphere, for example, an inert gas, such as N₂. It will be appreciated that a mild vacuum could be applied to such an embodiment, for example, at the pressures mentioned above.

According to preferred embodiments of the invention the triglyceride composition (TGC) comprises at least 50% by weight of mono unsaturated symmetric triglycerides (TGs) selected from the group consisting of POP, StOSt and POSt, wherein P is palmityl (i.e. palmitic acid), St is stearyl (i.e. stearic acid) and O is oleyl (i.e. oleic acid), such as at least 55% by weight or even at least 60% by weight. The richer the TGC starting composition is in symmetric triglycerides, the more asymmetric triglycerides that may be formed during the deodorization step of the present invention, wherein the asymmetric mono-unsaturated triglycerides (SSO) formed comprise P or St. This in turn allows for the formation of effective bloom-retarding components, as well as the benefit of a reduced level of glycidol, 2-MCPD, 3-MCPD, or esters thereof.

In a particularly preferred embodiment, said TGC comprises 55 to 85 wt % TGs selected from POP, StOSt, and POSt.

In some embodiments of the inventive process, the TGC may, prior to the heat treatment step, be subjected to a pre-treatment step, for example to remove included and dissolved oxygen. Such a step may include stripping the TGC with an inert gas, such as N₂, or saturated water steam, at a temperature of maximum 220° C. (such as 180 to 220° C.) for a minimum of 5 minutes (such as 5 to 30 minutes).

According to embodiments of the present invention the deodorization step may be performed for 10 minutes to 10 hours, such as 15 minutes to 8 hours, or even 20 minutes to 6 hours. Particularly contemplated is a period of 20 minutes to 150 minutes, and preferably 20 to 60 minutes.

In principle, any standard known deodorization processes in the art for vegetable triglyceride compositions could be used. In an embodiment of the present invention, the deodorization step may be operated at a temperature of from about 160° C., for example from 180° C., or even from 200° C.

In an embodiment of the present invention, the deodorization step may be operated at a temperature of below about 240° C., for example below 220° C.

Thus, further embodiments of the present invention include operating the deodorization step at a temperature of from 160° C. to 240° C., such as 200° C. to 220° C.

By way of example, in accordance with the present invention, the deodorization step may be operated from 10 minutes to 10 hours at a temperature of from 160° C. to 240°, preferably from 20 to 150 minutes, at a temperature of 200 to 220° C.

The exact pressure used during the deodorization step is not believed to be particularly critical. Generally, the pressure may be in the range of about 0 mbar (such as about 0.1, 0.5, 1, 1.5, 2, 2.5, 3, 3.5, 4, 4.5 or 5 mbar) to about 200 mbar (including 10, 20, 30, 40, 50, 60, 70, 80, 90, 100 and 150 mbar). Further embodiments include pressure ranges of 0 to 20 mbar, and more particularly 0 to 10 mbar). It will be appreciated that a mix of pressure conditions may also be used, such as an initially high pressure for a certain time followed by lower pressure for a certain time, or vice versa, i.e. an initially low pressure for some time followed by a higher pressure for a certain time.

Still further embodiments of the invention are where said deodorization step is operated for a period of 10 minutes to 10 hours, at a temperature of 160° C. to 240° C. and at a pressure of 0 to 20 mbar. For example, the deodorization step may be operated for 20 to 150 minutes, at a temperature of 200 to 220° C. and at a pressure of 0 to 10 mbar.

In accordance with an embodiment of the present invention, the heat treatment step and the deodorization step may be consecutive, i.e. the HT TGC is, subsequent to the heat treatment step, deodorized without any further processing of the HT TGC. Thus, the bulk HT TGC composition is unchanged before being subjected to the deodorization step.

In an alternative embodiment of the present invention, further method steps may be performed between the heat treatment step and deodorization step, i.e. the HT TGC is further processed prior to deodorization. The further method steps may include one or more further steps selected from bleaching, adsorption, filtering and/or fractionation. Such steps are well known to those of skill in the art, and are considered to be standard.

In further embodiments of the invention, the DZ/HT TGC may be fractionated after the deodorization step. Suitable fractionation processes include those allowing for the fractionation of trisaturated triglycerides (S3), i.e. PPP, PPSt, PStSt and StStSt, from the desired mono-unsaturated asymmetric triglycerides (SatSatU) formed according to the invention. Such fractionation processes allow the amount of the desired mono-unsaturated asymmetric triglycerides in the deodorized composition to be increased compared to the amount of trisaturated triglycerides. For example, removing even a few percent and more of trisaturated triglycerides will increase the ratio of SatSatU/S3 in a positive manner and, for example, improve the viscosity of the resulting composition. Suitable fractionation processes include, for example, dry or solvent fractionation processes, which as noted above are well known to those of skill in the art.

In accordance with the methods of the present invention, the DZ/HT TGC may be blended with a fat composition for chocolate or chocolate-like products (FCCH), such as in an amount of 0.1% and 97% by weight of the fat composition, such as in an amount of between 5% and 55% by weight of the fat composition, or in an amount of between 10% and 35% by weight of the fat composition. It will be appreciated by those of skill in the art, that the amount which is added is dependent on the desired bloom-retarding properties and desired textural properties, as well as the need to maintain reduced levels of glycidol, 2-MCPD, 3-MCPD, or esters thereof of in the final chocolate or chocolate-like product.

In other embodiments 1%, 2%, 5%, 10%, 20%, 30%, 40%, 50%, 60%, 70%, 80%, 90%, 95% or even 99% of the DZ/HT TGC is blended with a fat composition for chocolate or chocolate-like products (FCCH).

In some embodiments, the chocolate or chocolate-like products formed have a % S3 value of less than 2.56%, preferably the % S3 value of the chocolate or chocolate-like product formed is between 1.50 and 2.50%, for example from 1.75 to 2.25%.

The DZ/HT TGC may of course be used as the only fat component in a chocolate or chocolate-like product, and would therefore form 100% of the fat composition for the chocolate or chocolate-like product.

It has surprisingly been found that the addition of DZ/HT TGC, produced according to the present inventive process, to a fat composition in a wide range of amounts may positively influence the bloom properties of a chocolate or chocolate-like product comprising such a fat composition whilst being able to provide reduced levels of glycidol, 3-MCPD, 2-MCPD, or esters thereof. Such a combination of beneficial features is nowhere taught or even suggested in the art.

Said reduction, depending on the starting components, may be as much as 10%, 20%, 30%, 40% or even 50% and greater. For example, the reduction in 3-MCPD has been found to be greater than 50% and the reduction in glycidol greater than 60%, 70%, 80% and even 90%, when compared to say the process of WO2014/071955, on a like-for-like comparison.

In preferred embodiments, said reduction of glycidol, 2-MCPD, 3-MCPD, or esters thereof is at least 50% compared to, for example, the method described in WO2014/071955, on a like-for-like comparison.

A further benefit of the DZ/HT TGC produced according to the methods described herein in chocolate and chocolate-like products, is that the addition of other bloom-retarding substances or compositions may be partially or totally omitted, while still achieving excellent bloom-retarding properties in the final product.

In particular it may be very advantageous to be able to achieve excellent bloom-retarding effect without adding catalytically interesterified compositions or other components based on fats or oils that are not naturally present in cocoa butter.

In addition, with respect to CBEs, it may be very advantageous to produce the CBE using fats and oils that are not chemically modified using catalysts. Importantly it has been found that the texture of chocolate and chocolate-like products produced using chemically modified fats and oils is significantly inferior to those produced using the DZ/HT TGC of the present inventions.

In a preferred embodiment, the FCCH may comprise cocoa butter and/or a cocoa butter equivalent (CBE). The FCCH may consist essentially of cocoa butter and/or cocoa butter equivalent (CBE) and, in some embodiments may consist of cocoa butter and/or cocoa butter equivalent (CBE).

Where the DZ/HT TGC is blended with cocoa butter, it may be blended in an amount of 5-97% by weight of the cocoa butter, such as 10-70% by weight of the cocoa butter or 20-50% by weight of the cocoa butter.

In preferred embodiments, the blended DZ/HT TGC and cocoa butter may have a SSO/SSS ratio of from 0.4 to 1.7, more preferably from 0.5 to 1.6, and most preferably from 0.8 to 1.5.

In the methods of the present invention, the TGC may be selected from the group consisting of cocoa butter, shea oil (Butyrospermum parkii), palm oil (Elaeis guineensis, Elaeis olifera), illipe oil (Shorea spp.), mango oil (Mangifera indica), sal oil (Shorea robusta), kokum oil (Garcinia indica), any fraction thereof or any combination thereof. In a preferred embodiment the TGC is cocoa butter.

In one particular embodiment, the TGC is selected from cocoa butter and blended with a standard cocoa butter in an amount of 5-97% by weight of the standard cocoa butter, such as 10-70% by weight of the standard cocoa butter or 20-50% by weight of the standard cocoa butter.

The person of skill in the art would also understand that specific combinations of triglycerides may be used accordingly to the intended need and requirements.

In further embodiments of the methods of the invention, milk fat may be added to the TGC pre/before the heating step.

It has been found that adding the milk fat to the TGC before the heat teat treatment step avoids the bloom-retarding properties of the DZ/HT TGC being compromised as would ordinarily be expected, whilst at this same time improving the nutritional profile of the final DZ/HT TGC obtained.

In one advantageous embodiment of the invention the TGC is a CBE, cocoa butter, or a combination thereof, which as noted above, may further comprise milk fat.

Another aspect of the invention provides a deodorized, heat treated, triglyceride composition (DZ/HT TGC), or blend thereof, produced in accordance with any of the methods described above.

The DZ/HT TGC is particularly useful for the manufacture of chocolate or chocolate-like products. In particular, such chocolate or chocolate-like products can be produced without the addition of other vegetable fats which means that all of the vegetable fat in the chocolate or chocolate-like product has been solely produced according to the methods of the invention described herein. However, it will be appreciated that the DZ/HT TGC may be blended with other vegetable fats (such as described above) in order to obtain desired properties for specific chocolate or chocolate-like products. Such chocolate or chocolate-like products will have improved bloom properties as well as reduced levels of glycidol, 2-MCPD, 3-MCPD, or esters thereof. Thus, the method of the present invention also comprises further processing the DZ/HT TGC, or blend thereof, to form a chocolate or chocolate-like product (such as described below).

Accordingly, a further aspect of the present invention relates to a chocolate or chocolate-like product comprising a deodorized heat-treated triglyceride composition (DZ/HT TGC), or blend thereof, produced in accordance with the methods described herein.

In a preferred embodiment, the chocolate or chocolate-like product comprises at least 2% by weight of the deodorized heat-treated triglyceride composition (DZ/HT TGC), or blend thereof.

In some embodiments, the chocolate or chocolate-like product may comprise up to 95% by weight of DZ/HT TGC, or blend thereof.

By way of further example, the chocolate or chocolate-like product may comprise at least 5%, 10%, 20% or even 40% of DZ/HT TGC, or blend thereof. By way of still further example, the chocolate or chocolate-like product may comprise less than 90%, 80%, 70% or even 60% of DZ/HT TGC, or blend thereof.

The DZ/HT TGC (or blend thereof) may be mixed with cocoa butter and/or a cocoa butter equivalent or combinations thereof. It has been found by the present inventors that when DZ/HT TGC (with or without milk fat in small amounts as described herein) is blended with cocoa butter and/or a cocoa butter equivalent, it is possible to obtain a bloom-retarding effect in the final product comprising the blend, whilst obtaining the additional benefit of reduced levels of glycidol, 2-MCPD, 3-MCPD and/or esters thereof.

Likewise, a further aspect of the present invention is directed to a method of manufacturing a chocolate or chocolate-like product comprising the DZ/HT TGC, or blend thereof, such as described above.

In a preferred embodiment, the DZ/HT TGC, or blend thereof, is the only vegetable fat added to the chocolate or chocolate-like product, i.e. it forms 100% of the vegetable fat added to the chocolate or chocolate-like product.

In another preferred embodiment, the DZ/HT TGC, or blend thereof, (with or without milk fat having been added), may be advantageously blended with a CBE, CBS, CBI and/or cocoa butter to produce a superior chocolate or chocolate-like product. They may also be blended with a standard cocoa butter (i.e. one not processed in accordance with the present inventive processes but known prior art methods) to produce a superior chocolate or chocolate-like product. Such chocolate or chocolate-like are, at least in part, superior due to their bloom-retarding properties as well as reduced levels of glycidol, 2-MCPD, 3-MCPD, or esters thereof.

In another aspect of the invention, there is provided a chocolate or chocolate-like product comprising, as the only fat component cocoa butter, and wherein at least 2%, such as at least 4%, and even such as at least 6% by weight of the cocoa butter has been produced in accordance with the methods described herein. The amount of cocoa butter produced in accordance with the methods described herein may be up to 100%, but also contemplated are ranges such as 10 to 95%, 25 to 90% and 75 to 85%. Such a chocolate or chocolate-like product will not only possess improved bloom-retarding properties but also the added benefit of reduced levels of glycidol, 2-MCPD, 3-MCPD, or esters thereof.

The chocolate or chocolate-like products of the present inventions may comprise from 1.1 to 2.5 wt % SSO triglyceride and 1.5 to 2.6 wt % trisaturated triglyceride (S3) by weight of the vegetable fats, preferably the trisaturated triglyceride (S3) is present in amounts of from 1.5 to 2.5 wt %, more preferably from 1.5 to 2.4 wt %, even more preferably from 1.5 to 2.3 wt %, and most preferably from 1.5 to 2.2 wt %, by weight of the vegetable fats.

In particularly preferred embodiments, the chocolate or chocolate-like products comprise from 1.4 to 1.8 wt % SSO triglyceride and 1.5 to 2.6 wt % trisaturated triglyceride (S3) by weight of the vegetable fats, preferably the trisaturated triglyceride (S3) is present in amounts of from 1.5 to 2.5 wt %, more preferably from 1.5 to 2.4 wt %, even more preferably from 1.5 to 2.3 wt %, most preferably from 1.5 to 2.2 wt %, by weight of the vegetable fats. The vegetable fat is preferably selected from cocoa butter.

In a further aspect of the present invention, the chocolate or chocolate-like product preferably comprises a SSO/SSS ratio of from 0.4 to 1.7, preferably from 0.5 to 1.6, more preferably from 0.8 to 1.5.

The relative content of trisaturated triglycerides (S3) has surprisingly been found to have a significant impact on the viscosity of the resulting tempered chocolate. As the S3 content increases, the plastic viscosity (PV) and the yield value (YV) of the chocolate also increases. However, at a certain S3 content, the viscosity of the chocolate increases to such an extent that it is detrimental to further required processing steps, such as molding and/or coating steps. As should be appreciated, it is desirable to maintain an optimal and constant PV and YV during manufacturing of chocolate as it is the plastic viscosity and yield value properties which define the layer thickness of a coated product, the chocolate distribution in molds, and air bubble release from chocolate. In addition, the plastic viscosity and yield value properties of the chocolate can also affect the resulting sensory properties.

Whilst it is known that the PV and YV of a given chocolate can be adjusted by incorporating additional amounts cocoa butter to the mixture, such steps inevitably increase costs. In addition, the inclusion of additional amounts of cocoa butter can cause undesirable changes to the overall chocolate sensory perception.

Yet a further aspect of the invention is concerned with the use of a deodorized heat-treated triglyceride composition (DZ/HT TGC) according to any of the aspects of the present invention as a bloom-retarding component for chocolate and chocolate-like products.

The present inventions will now be described in yet further detail with respect to the following examples.

### EXAMPLES

### Example 1—Method for Obtaining Bloom-Retarding Fat Composition with Low Content of Glycidol, 2-MCPD and 3-MCPD

Example 1 describes the production of a bloom-retarding component in accordance with the present invention having a reduced content of glycidol, 2-MCPD and 3-MCPD in the final fat composition.

Table 1 compares two methods: Process A, which has been prepared in accordance with the disclosure of WO2014/071955; and Process B which has been prepared in accordance with the present invention. In both cases the starting oil is a West African PPP cocoa butter (CB) from exactly same batch, and a 4 kg cocoa butter sample is used.

TABLE 1

| | | Process A | |
|---|---|---|---|
| | | (prior art) | Process B |
| Starting CB | Glycidyl ester in ppm | <0.1 | <0.1 |
| Full deodorized | (determined as free glycidol) | | |
| pure prime | Sum of free 2-MCPD, 2-MCPD ester in ppm | <0.1 | <0.1 |
| pressed | (determined as free 2-MCPD) | | |
| | Sum of free 3-MCPD, 3-MCPD ester in ppm | <0.1 | <0.1 |
| | (determined as free 3-MCPD) | | |
| | Sum of SSO in ppm (S is either stearyl (St) | <0.5 | <0.5 |
| | or palmityl (P), O is oleic) | | |
| | Sum of SSS in ppm (S is either stearyl (St) | 1.7 | 1.7 |
| | or palmityl (P)) | | |
| | Ratio of SSO/SSS | <0.6 | <0.6 |
| | FFA | 1.7 | 1.7 |
| Heat treatment | Temperature (° C.) | 260 | 250 |
| step | Time (hours) | 6 | 6 |
| | Pressure (mBar) | 8 | 150 |
| | Sealed vessel | No | Yes |
| | Nitrogen cover | No | Yes |
| | Mechanical mixing | No | Yes |
| Analysis of CB | Glycidyl ester in ppm | 7.15 | 0.72 |
| after | (determined as free glycidol) | | |
| Heat treatment | Sum of free 2-MCPD, 2-MCPD ester in ppm | 0.19 | <0.1 |
| step | (determined as free 2-MCPD) | | |
| | Sum free 3-MCPD, 3-MCPD ester in ppm | 0.26 | 0.15 |
| | (determined as free 3-MCPD) | | |
| | Sum of SSO in ppm (S is either stearyl (St) | 4.5 | 4.6 |
| | or palmityl (P), O is oleic) | | |
| | Sum of SSS in ppm (S is either stearyl (St) | 3.1 | 3.2 |
| | or palmityl (P)) | | |
| | Ratio of SSO/SSS | 1.5 | 1.4 |
| | FFA | 0.04 | 1.6 |
| Deodorization | Temperature (° C.) | 210 | 210 |
| step | Time (hours) | 8 | 2 |
| | Pressure (mBar) | 3 | 3 |
| | Open vessel, deodoriser | Yes | Yes |
| | Steam stripping gas | Yes | Yes |
| Analysis of CB | Glycidyl ester in ppm | 2.34 | 0.45 |
| after | (determined as free glycidol) | | |
| Deodorization | Sum free 2-MCPD, 2-MCPD ester in ppm | 0.12 | <0.1 |
| step | (determined as free 2-MCPD) | | |
| | Sum free 3-MCPD, 3-MCPD ester in ppm | 0.19 | <0.1 |
| | (determined as free 3-MCPD) | | |
| | Sum of SSO in ppm (S is either stearyl (St) | 4.7 | 4.7 |
| | or palmityl (P), O is oleic) | | |
| | Sum of SSS in ppm (S is either stearyl (St) | 3.4 | 3.3 |
| | or palmityl (P)) | | |
| | Ratio of SSO/SSS | 1.4 | 1.4 |
| | FFA | 0 | 0 |

As can be clearly seen in Table 1, the process of the present invention (Process B) is able to produce the same bloom inhibiting triglycerides (SSO) as WO2014/071955, and keep an optimal SSO/SSS ratio, but with the major benefit of significantly lower amounts of glycidol, 2-MCPD and 3-MCPD.

An additional surprising benefit of the process of the present invention is the reduction in time required for the deodorization step, which is due to the greatly reduced formation of glycidol, 3-MCPD and 2-MCPD in step 1 when using the new process invention.

### Example 2—Chocolate

Example 2 describes the making of chocolate using the bloom-retarding fat compositions obtained from Processes A and B in Example 1, as well as a chocolate formed from a standard deodorized cocoa butter as follows:
Fat A is cocoa butter produced in accordance with Process A;
Fat B is cocoa butter produced in accordance with Process B; and
Fat C is a standard deodorized cocoa butter, processed for 2 hours at 190° C., and which has not been produced in accordance with Process A or B. C is a reference and comparable with the starting cocoa butter (CB) in Table 1.

Table 2 below shows the content of SSO triglycerides (which are bloom inhibiting) in the three different Fats A to C.

TABLE 2

| | Fat A | Fat B | Fat C |
|---|---|---|---|
| Sum of SSO (S is either stearyl | 4.7 | 4.7 | <0.5 |
| (St) or palmityl (P), O is oleic) | | | |

The three Fats A to C were formed into chocolates in accordance with the recipes in Table 3, with cocoa butter as the only vegetable fat.

TABLE 3

| | Chocolate A | Chocolate B | Chocolate C |
|---|---|---|---|
| Fat A | 10.0 | 0.0 | 0.0 |
| Fat B | 0.0 | 10.0 | 0.0 |
| Fat C | 20.0 | 20.0 | 30.0 |
| Cocoa powder (11% fat) | 15.0 | 15.0 | 15.0 |
| Skim milk powder | 6.0 | 6.0 | 6.0 |
| Sugar | 48.6 | 48.6 | 48.6 |
| Lecithin | 0.4 | 0.4 | 0.4 |
| Total fat content. | 31.7 | 31.7 | 31.7 |

All ingredients for each respective Chocolate A to C, were mixed together except the lecithin and a part of the fat (this is a known method in the art for producing chocolate, where essentially fat is added in an amount necessary to obtain a ‘marzipan’ like consistency which can then be easily refined). The mixture was refined on a Bühler 300m refiner to a particle size of 20 microns.

The refined mass was then conched for 6 hours in a small Hobert N50 mixer having a 60° C. water jacket. After 4 hours, the remainder of the fat was added to the mixture, and after 5.5 hours the lecithin was added to the mixture.

After conching, the final chocolate product was cooled to 40° C. and tempered on a marble table. The final chocolate product was analyzed for perfect tempering using common procedures and then deposited into 100 gram molds which were cooled in a standard cooling tunnel with three zones for 30 min.

Zone 1 was at 15° C., zone 2 was at 12° C. and zone 3 was at 15° C.

The 100 gram tablets were stored at 20° C. for 4 days before being subjected to different storage conditions for bloom testing as described below.

Bloom evaluation was undertaken using a standardized visual evaluation, and assessing the time taken for strong visual bloom development on the surface to occur. The results are shown in Table 4 below as the time in days for strong visual bloom to develop on the chocolate surface.

The temperature cycle test was performed by taking the stored tablets, and storing them for twelve hours at 25° C. followed by twelve hours at 31° C. and cycling between these two temperatures with intermittent evaluation of the bloom development on the surface at 20° C.

TABLE 4

| | Chocolate A | Chocolate B | Chocolate C |
|---|---|---|---|
| 25° C. isotherm (days) | 112 | 122 | 35 |
| 20° C. −> 25° C./31° C. cycle | 19 | 23 | 10 |
| (days) | | | |

It can be readily seen from Table 4 that Chocolate C, comprising a standard deodorized cocoa butter is significantly inferior to Chocolates A and B. Chocolates A and B, which were produced from Fats A and B (which fats were deodorized at higher temperatures and for longer times), both show superior properties.

Table 4 also shows that Chocolate B, which contains Fat B produced in accordance with the process of the present invention, is superior to that of Chocolate A, this despite the fact that it has been processed in order to prevent the formation of glycidyl ester, 2-MCPD and 3-MCPD. Such high temperature treatment would ordinarily be expected to have the opposite effect on glycidyl ester, 2-MCPD and 3-MCPD content. Not only that, but the common general knowledge in this field is that high temperature processing of such compositions should be kept to a minimum, low temperatures used wherever possible, and the process time as short as possible to avoid undesirable chemical changes in the symmetry (such processing being generally known to increase asymmetry which results in poorer crystallization properties) of the fats in the compositions.

### Example 3—Effect of the Bloom-Retarding Fat Composition on the Plastic Viscosity and Yield Value of Chocolate

Example 3 describes the effect of the trisaturated triglyceride content of a bloom-retarding fat composition on the plastic viscosity and yield value of the resulting chocolate formed.

Six different cocoa blends were formed comprising a trisaturated component A as defined in Table 5.

TABLE 5

| Component | A |
|---|---|
| Full hydrogenated palm stearin IV 34 | 75% |
| Full hydrogenated Rapeseed oil | 25% |

The six different cocoa butter blends (I to IV) contained varying amounts of the component A, as illustrated in Table 6. Each of the cocoa butter blends were heated to 90° C. to ensure complete melting and a homogeneous mixture of the blends formed. The S3 content of each of the blends was determined using the AOCS Official Method defined in Ce 5b-89, wherein P is palmitic acid and St is stearic acid.

TABLE 6

| | Cocoa butter mixtures | | | | | |
|---|---|---|---|---|---|---|
| | I | II | III | IV | V | VI |
| % Pure prime press Cocoa | 100 | 98.35 | 96.7 | 95.0 | 93 | 89 |
| butter | | | | | | |
| % Component A | 0 | 1.65 | 3.3 | 5.0 | 7.0 | 11 |
| % S3 (Σ PPP, PPSt, PStSt, | 1.5 | 3.12 | 4.75 | 6.43 | 8.40 | 12.34 |
| StStSt ) | | | | | | |

A dark chocolate concentrate was formed based on the composition defined in Table 7.

TABLE 7

| Ingredients | % |
|---|---|
| Sugar | 52.16 |
| Cocoa mass | 42.10 |
| Cocoa butter | 5.30 |
| Lecithin | 0.44 |

The dark chocolate concentrate was formed by mixing the sugar, cocoa mass and cocoa butter in a Mèlangeur. The mixture was then refined on a Lehman 3 rolls refiner to an average particle size at 20 micron. The refined material was subsequently conched in a Bauermeister concher for 16 hours in total at 60° C. After 15.5 hours conching the lecithin was added and the conching continued for a further 30 minutes. The 60° C. hot chocolate concentrate was then divided into six batches and a preheated cocoa butter mixtures I to VI, as defined in Table 6 was added to each of the six batches of chocolate concentrate as illustrated in Table 8, forming chocolate compositions VII to XII, respectively.

TABLE 8

| | Dark chocolate | | | | | |
|---|---|---|---|---|---|---|
| Ingredients | VII | VIII | IX | X | XI | XII |
| Chocolate concentrate | 95 | 95 | 95 | 95 | 95 | 95 |
| Table 7 | | | | | | |
| Cocoa butter mixtures I | 5 | | | | | |
| Cocoa butter mixtures II | | 5 | | | | |
| Cocoa butter mixtures III | | | 5 | | | |
| Cocoa butter mixtures IV | | | | 5 | | |
| Cocoa butter mixtures V | | | | | 5 | |
| Cocoa butter mixtures VI | | | | | | 5 |
| % S3 (Σ PPP, PPSt, | 1.50 | 1.75 | 2.00 | 2.26 | 2.56 | 3.17 |
| PStSt, StStSt ) | | | | | | |

Each of the dark chocolate compositions VII to XII were tempered in an Aasted tempering machine AMC50 to a well-tempered chocolate. Once a well-tempered chocolate was formed, a small sample of the chocolate was transferred to a preheated Brookfield small sample adapter and the Casson plastic viscosity and yield value was measured and calculated for each sample.

A Spindle SC27 was used to measure the viscosity of each of the dark all chocolates at their outlet temperature from the tempering machine, which are 28.0° C.+/−0.1° C.

The plastic viscosity and the yield values for the well-tempered dark chocolate compositions VII to XII are illustrated in Table 9.

TABLE 9

| | Plastic viscosity cP | Yield value Dynes/cm2 |
|---|---|---|
| Chocolate VII | 3939 | 125 |
| Chocolate VIII | 3942 | 117 |
| Chocolate IX | 4444 | 127 |
| Chocolate X | 5003 | 122 |
| Chocolate XI | 5767 | 182 |
| Chocolate XII | 8307 | 199 |

It is clear from Table 9 that dark chocolate compositions containing a % S3 above a certain threshold also illustrate an increase in plastic viscosity and yield value. It is immediately clear from Table 9 and corresponding FIGS. 1 and 2 that significant and undesirable increases in yield value were observed in samples above 2.26, and in the plastic viscosity of the dark chocolate composites in samples containing 2.56% S3 and above.

Chocolate based on pure prime press cocoa butter will typically have a S3 content of between 1.5-1.9% depending on the cocoa butter quality and origin, and no detectable content of mono-unsaturated assymtric TAGs (SSO). Example 1 and Table 1 demonstrate that it is possible using processes A and B to get a high ratio between a cocoa butters content of SSO TAGs and S3 TAGs. A high ratio between SSO and S3 beneficial as this enables the inclusions of optimals amount of the bloom retarding SSO triglycerides to a chocolate without significantly increasing the % S3 triglyceride. Thus, the resulting chocolate provides an improved bloom retarding effect whilst minimising the change in the viscosity (PV/YV) properties, due to the low amounts S3. Thus is it has surprisingly been found that it is the overarching ratio of SSO to S3 which is important, not merely the content of SSO as previously thought in the art.

If the same bloom retarding effect was achieved by adding incorporating a chemical interestrified cocoa butter, the chocolates viscosity would have been significant higher as a result of the higher S3 content.

1-28. (canceled)

29. A method for producing a bloom-retarding component for chocolate and chocolate-like products, said method comprising the steps of:
providing a triglyceride composition (TGC) comprising 40 to 95 wt % monounsaturated symmetrical triglycerides (TGs) selected from POP, StOSt, and POSt;
heat treating the TGC in a sealed vessel for at least 1 hour and at a temperature of at least 220° C. to form a heat-treated triglyceride composition (HT TGC); and
deodorizing the HT TGC from the heating step to form a deodorized heat-treated triglyceride composition (DZ/HT TGC);
wherein P is palmitic acid, St is stearic acid and O is oleic acid.

30. The method according to claim 29, wherein the TGC, prior to the heat treatment step, is stripped with an inert gas, or a saturated water steam, at a temperature of no more than 220° C. and for a minimum of 5 minutes.

31. The method according to claim 29, wherein the TGC comprises 55 to 85 wt % TGs selected from POP, StOSt, and POSt.

32. The method according to claim 29, wherein the heat treatment step is undertaken for 1 to 8 hours and/or at a temperature of 220 to 260° C.

33. The method according to claim 32, wherein the heat treatment step is undertaken for 4 to 6 hours and/or at a temperature of 245 to 260° C.

34. The method according to claim 29, wherein the sealed vessel is under vacuum up to a maximum of 2 mbar.

35. The method according to claim 29, wherein the sealed vessel is operated under an inert atmosphere.

36. The method according to claim 29, wherein said HT TGC is deodorized for 10 minutes to 10 hours, at a temperature of 160° C. to 240° C., and at a pressure of 0 to 20 mbar.

37. The method according to claim 36, wherein said HT TGC is deodorized for 20 to 150 minutes, at a temperature of 200 to 220° C., and at a pressure of 0 to 10 mbar.

38. The method according to claim 29, wherein the HT TGC is subsequently deodorized without any further processing of the HT TGC before deodorization.

39. The method according to claim 29, wherein the HT TGC is further processed prior to deodorization.

40. The method according to claim 29, further comprising the step of blending the DZ/HT TGC with a fat composition for chocolate or chocolate-like products (FCCH) in an amount of 0.1% to 97% by weight of the fat composition.

41. The method according to claim 40, wherein the FCCH comprises cocoa butter and/or a cocoa butter equivalent.

42. The method according to claim 41, wherein the blended CZ/HT TGC and FCCH has a SSO/SSS ratio of 0.4 to 1.7.

43. The method according to 40, wherein the FCCH is cocoa butter, and the DZ/HT TGC is blended with the cocoa butter in an amount of 5 to 97% by weight of the cocoa butter.

44. The method according to 29, wherein the TGC is selected from the group consisting of cocoa butter, shea oil (Butyrospermum parkii), palm oil (Elaeis guineensis, Elaeis olifera), illipe oil (5′horea spp.), mango oil (Mangifera indica), sal oil (Shorea robusta), kokum oil (Garcinia indica), any fraction thereof and/or any combination thereof.

45. The method according to claim 44, wherein the TGC is cocoa butter.

46. The method according to claim 29, further comprising adding milk fat to the TGC prior to the heat treatment step.

47. A DZ/HT TGC, or blend thereof, produced in accordance with claim 29.

48. A method of manufacturing a chocolate or chocolate-like product comprising the step of adding a DZ/HT TGC, or blend thereof, according to claim 47 as the only vegetable fat.

49. A chocolate or chocolate-like product comprising a DZ/HT TGC, or blend thereof, according to claim 47.

50. A chocolate or chocolate-like product according to claim 49, having a SSO/SSS ratio of 0.4 to 1.7.

51. A chocolate or chocolate-like product according to claim 49, comprising at least 2% of a DZ/HT TGC.

52. A chocolate comprising cocoa butter as the only vegetable fat component and wherein at least 2% by weight of the cocoa butter has been processed in accordance with claim 29.

53. A chocolate according to claim 29, comprising cocoa butter as the only vegetable fat component, and comprising 1.1 to 2.5 wt % SSO triglyceride and 1.5 to 2.6 wt % trisaturated triglyceride (S3) by weight of vegetable fats.

54. A chocolate according to claim 53, comprising 1.4 to 1.8 wt % SSO triglyceride by weight of vegetable fats.

55. A chocolate according to claim 53, comprising 1.1 to 2.2 wt % SSO triglyceride and 1.5 to 2.5 wt % S3 by weight of vegetable fats.

56. The DZ/HT TGC according to claim 47, wherein the DZ/HT TGC is used as a bloom-retarding component for chocolate and chocolate-like products.
